(19) United States
(12) Patent Application Publication
(10) Pub. No.: US 2009/0094472 A1
(43) Pub. Date: Apr. 9, 2009

(54) Computer system and method for dynamically saving power thereof

(75) Inventor: Wei-Po Lin, Taipei (TW)

Correspondence Address: BACON & THOMAS, PLLC, 625 SLATERS LANE, FOURTH FLOOR, ALEXANDRIA, VA, 22314-1176, US

(73) Assignee: ASUSTek COMPUTER INC., Taipei (TW)

(21) Appl. No.: 12/230,886

(22) Filed: Sep. 8, 2008

(30) Foreign Application Priority Data
Oct. 8, 2007 (CN) 200710181129.7
Oct. 8, 2007 (TW) 96137721

(51) Int. Cl. G06F 1/32

(52) U.S. Cl. 713/324; 713/320

(57) ABSTRACT

A computer system and a method for saving power thereof are provided. The computer system includes a switch, a system power supply unit and an operation control unit. The switch is electrically connected to a peripheral component selectively. The system power supply unit is electrically connected to the switch. The operation control unit is electrically connected to the switch, and it detects whether an application program relative to the peripheral component is executed. Then, the operation control unit outputs the switch control signal to the switch to determine whether the system power supply unit provides the operation power for the peripheral component.

This application claims the benefit of Taiwan application Serial No. 96137721, filed Oct. 8, 2007, the subject matter of which is incorporated herein by reference.

### BACKGROUND OF THE INVENTION

1. Field of the Invention

The invention relates to a computer system and, more particularly, to a computer system and a method for dynamically saving power thereof.

2. Description of the Related Art

FIG. 1 is a schematic diagram showing a conventional computer system and a universal serial bus device. A conventional computer system 10 includes a central processing unit (CPU) 162, a chip set 166 and a system power supply unit 164. The chip set 166 includes a north bridge 1662 and a south bridge 1664, and the south bridge 1664 has, for example, Hot Plug and Play Host Controllers such as a universal serial bus (USB) host controller or a peripheral component interface express (PCI-E) controller.

The CPU 162 communicates with the south bridge 1664 via the north bridge 1662, and the south bridge 1664 can control a peripheral component 20 via a control signal wire 1666. The peripheral component 20 may include a USB device, IEEE 1394 devices, or a PCI-E device. The system power supply unit 164 can provide an operation power Vcc for the peripheral component 20.

When no application program relative to the peripheral component 20 is executed, the conventional computer system 10 still has two power-consuming conditions.

First, the peripheral component 20 continuously consumes power to maintain the operation of the internal integrated circuits.

Second, if the peripheral component controller in the south bridge 1664 is a USB host controller, the USB host controller continuously polls the state of the peripheral component 20 (such as the USB device) and generates an interrupt signal.

When the interrupt signal is generated, the CPU 162 is forced to enter an operation state from an original deep sleep state to process the interrupt signal. Since the CPU 162 cannot be in the deep sleep state for a long time, it continuously consumes the electricity of the battery.

### BRIEF SUMMARY OF THE INVENTION

The invention relates to a computer system and a method for dynamically saving power, and it determines whether to provide operation power for a peripheral component by detecting whether an application program (such as a VoIP or wireless network access program) relative to the peripheral component is executed. In this way, peripheral components that are not utilized by any application program are not provided with power to save the electricity of the battery of the computer system.

The invention provides a computer system. The computer system includes a switch, a system power supply unit and an operation control unit. The switch is electrically connected to a peripheral component selectively. The system power supply unit is electrically connected to the switch. The operation control unit is electrically connected to the switch, and it detects whether an application program relative to the peripheral component is executed and outputs a switch control signal to the switch to determine whether the system power supply unit provides the operation power for the peripheral component.

The invention provides a method for dynamically saving power. The computer system includes a switch and a system power supply unit. The method for dynamically saving power includes the following steps.

First, whether an application program relative to the peripheral component is executed is detected, and then a switch control signal is outputted. Next, the switch is controlled according to the switch control signal to determine whether the system power supply unit provides an operation power for the peripheral component.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a schematic diagram showing a conventional computer system and a peripheral component;

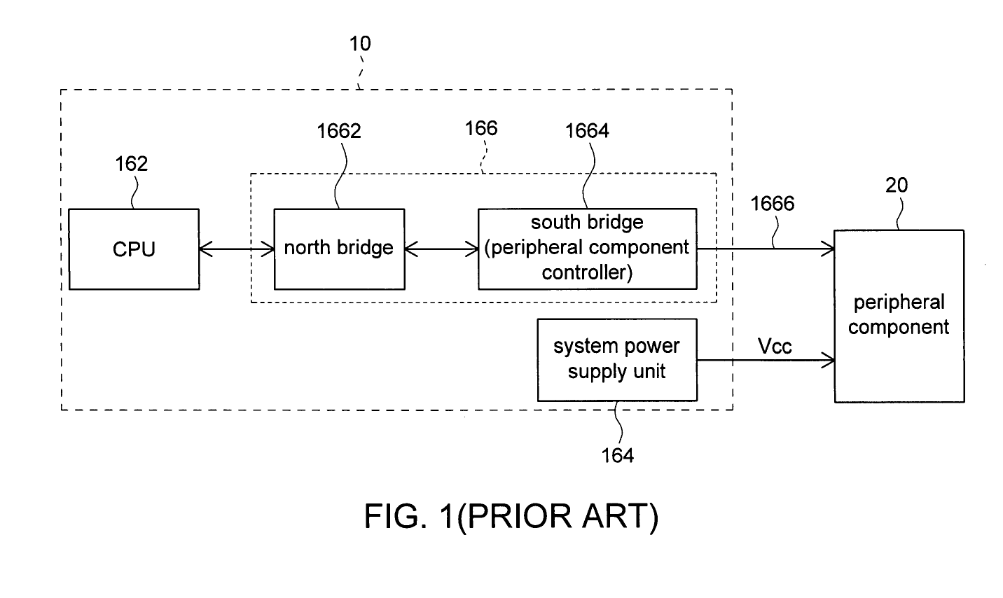

FIG. 2 is a schematic diagram showing a computer system according to a preferred embodiment of the invention;

FIG. 3 is a detailed schematic diagram showing the computer system in FIG. 2;

FIG. 4 is another detailed schematic diagram showing the computer system in FIG. 2; and

FIG. 5 is a flow chart showing a method for saving power in a computer system according to a preferred embodiment of the invention.

### DETAILED DESCRIPTION OF THE EMBODIMENTS

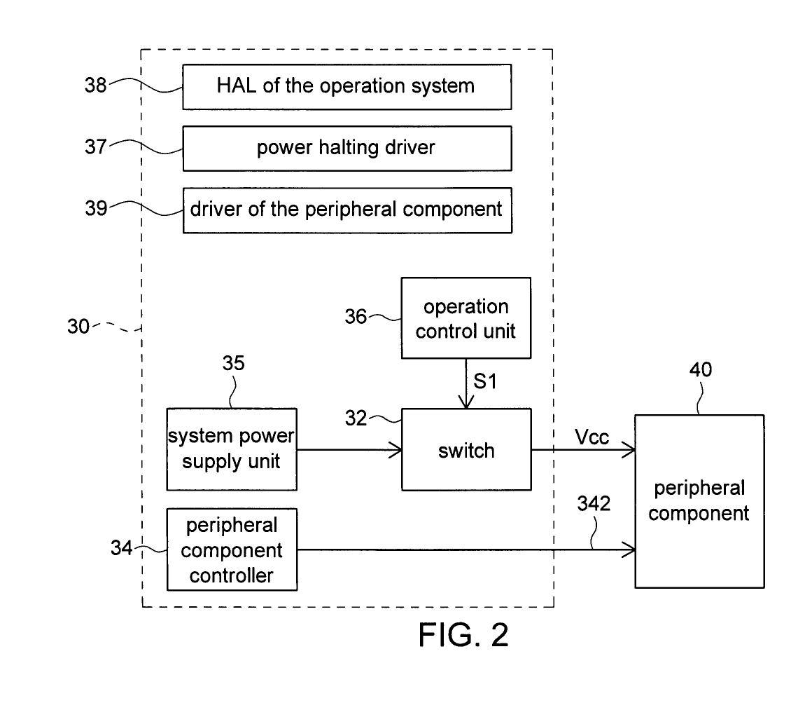

FIG. 2 is a schematic diagram showing a computer system according to a preferred embodiment of the invention. A computer system 30 includes a switch 32, a peripheral component controller 34, a system power supply unit 35 and an operation control unit 36.

The operation control unit 36 is electrically connected to the switch 32. The system power supply unit 35 is electrically connected to the switch 32. The switch 32 and the peripheral component controller 34 are electrically connected to a peripheral component 40, respectively.

In the embodiment, the computer system 30 may be a portable computer, and in other embodiment, the computer system 30 also may be a server or a desktop computer.

In the embodiment, the peripheral component controller 34 may be, for example, a blue-tooth controller, a universal serial bus (USB) host controller or a peripheral component interface express (PCI-E) controller. The peripheral component controller 34 controls the peripheral component 40 via a control signal wire 342.

The system power supply unit 35 provides an operation power Vcc for the peripheral component 40 when the switch 32 is turned on. In the embodiment, the peripheral component 40 may be, for example, a USB device or a PCI-E device. The USB device may be a global positioning system (GPS) module, a television (TV) module or a 3G wireless networks (WLAN) device, and the PCI-E device may be, for example, a PCI-E graphics card or a wireless local area networks (WLAN) device.

In the embodiment, the peripheral component 40 is preferred to be a peripheral component which can support hot plug and play standard. For example, the peripheral component 40 may be a USB peripheral device, a PCI-E peripheral device or an IEEE 1394 peripheral device. In the embodiment, the peripheral component controller 34 is preferred to be a peripheral component controller which can support hot plug and play standard. For example, the peripheral component controller 34 may be a USB controller, a PCI-E controller or an IEEE 1394 controller.

When the computer system 30 is operated, the central processing unit (CPU) of the operation control unit 36 executes a power halting driver 37 to detect whether an application program relative to the peripheral component 40 is executed. In the computer system 30, when any application program needs to start the specific peripheral component 40, it should control the peripheral component 40 via the hardware abstract layer (HAL) of the operating system and the driver. The power halting driver 37 of the embodiment is between the HAL 38 of the operating system and the driver 39 of the peripheral component 40. Therefore, the power halting driver 37 can know whether an application program needs to start or terminate the driver 39 of the peripheral component.

The power halting driver 37 outputs a relative command to the operation control unit 36 according to its detecting result, and then the operation control unit 36 outputs a switch control signal S1 to the switch 32 to selectively turn on or off the switch 32. For example, when the application program relative to the peripheral component 40 is not executed, the switch control signal S1 controls the switch 32 to turn off to stop providing the operation power Vcc for the peripheral component 40, and then the peripheral component 40 having, for example, a USB 2.0 interface enters a hot plug out state. On the contrary, when the application program relative to the peripheral component 40 is executed, the switch control signal S1 controls the switch 32 to turn on to provide the operation power Vcc for the peripheral component 40, and then the peripheral component 40 having, for example, the USB 2.0 interface enters a hot plug in state.

The computer system 30 utilizes the power halting driver 37 to detect whether the application program relative to the peripheral component 40 is executed to control the switch 32 to turn on or off. Therefore, in the embodiment, the system power supply unit 35 stops providing the peripheral component 40 that is not used by any application program with the power to save the electricity of the computer system 30.

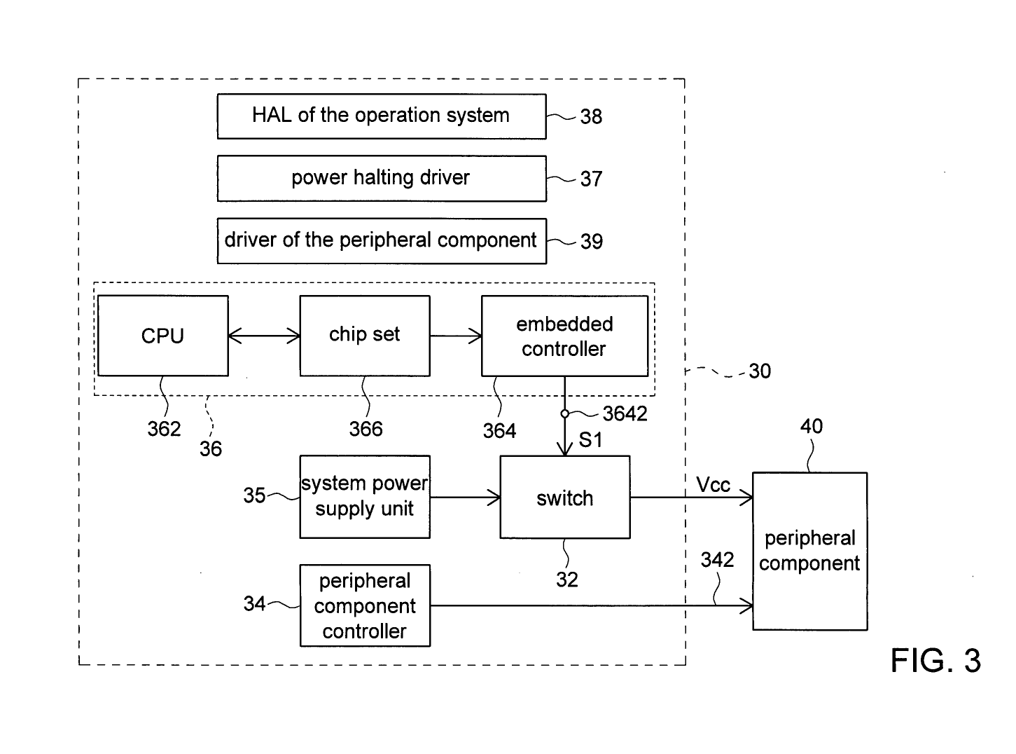

FIG. 3 is a detailed schematic diagram showing the computer system in FIG. 2. Furthermore, the operation control unit 36 further includes a CPU 362, a chip set 366 and an embedded controller (EC) 364. The chip set 366 includes a north bridge chip and a south bridge chip (not shown). The chip set 366 is electrically connected to the CPU 362 and the embedded controller 364, respectively. The embedded controller 364 is electrically connected to the switch 32.

The CPU 362 of the operation control unit 36 is used to execute the power halting driver 37 to detect whether an application program relative to the peripheral component 40 is executed.

In the embodiment, the power halting driver 37 may be, for example, an application program or a driver, and it can be developed by the software develop kit (SDK) or the driver develop kit (DDK) provided by the operating system.

The embedded controller 364 further includes a GPIO (general purpose input output) pin 3642 electrically connected to the switch 32. The embedded controller 364 programs the GPIO pin 3642 to output the switch control signal S1 according to whether the application program relative to the peripheral component 40 is executed.

In other words, the switch 32 is controlled by the GPIO pin 3642. When the GPIO pin 3642 is in a high state, the switch 32 is turned off, and then the system power supply unit 35 stops providing the operation power Vcc for the peripheral component 40. On the contrary, when the GPIO pin 3642 is in a low state, the switch 32 is turned on, and then the system power supply unit 35 provides the operation power Vcc for the peripheral component 40.

The power halting driver 37 can detect whether the application program relative to the peripheral component 40 is executed. In the embodiment, when the application program relative to the peripheral component 40 is not executed, the power halting driver 37 unloads the driver of the peripheral component 40. On the contrary, when the application program relative to the peripheral component 40 is executed, the power halting driver 37 loads the driver of the peripheral component 40.

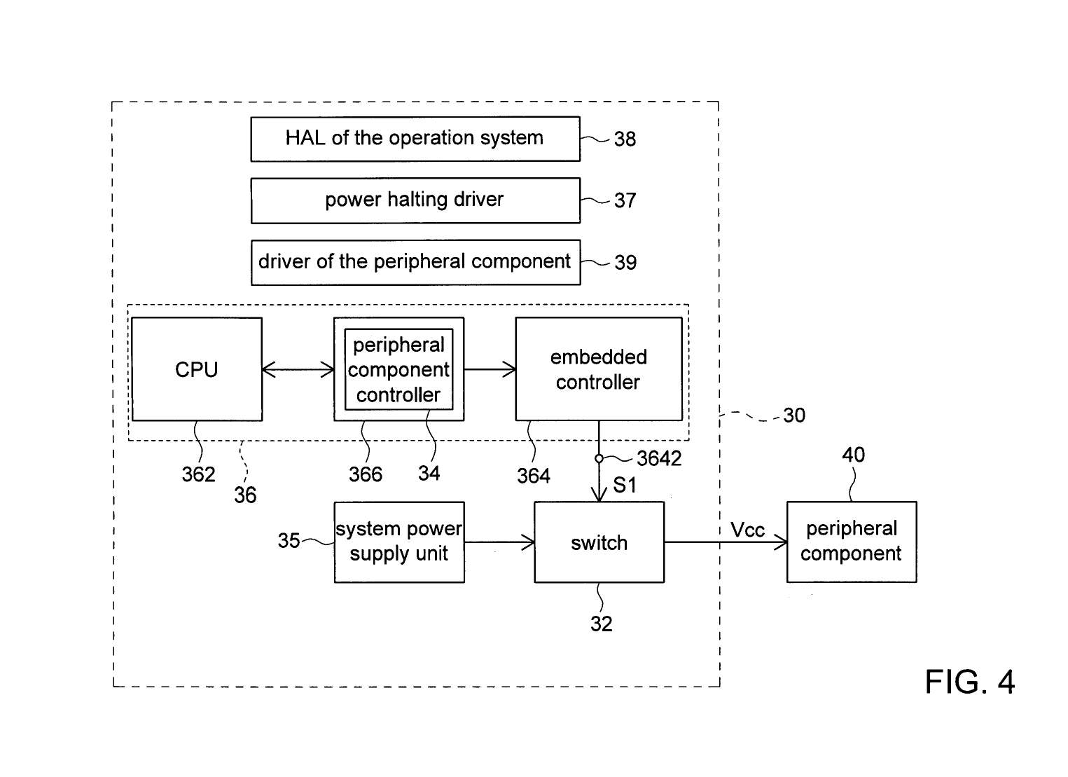

FIG. 4 is another detailed schematic diagram showing the computer system in FIG. 2. The peripheral component controller 34 may be disposed at the chip set 366 as shown in FIG. 4 besides the disposal mode in FIG. 3. For example, the peripheral component controller 34 also can be integrated into the south bridge chip of the chip set 366.

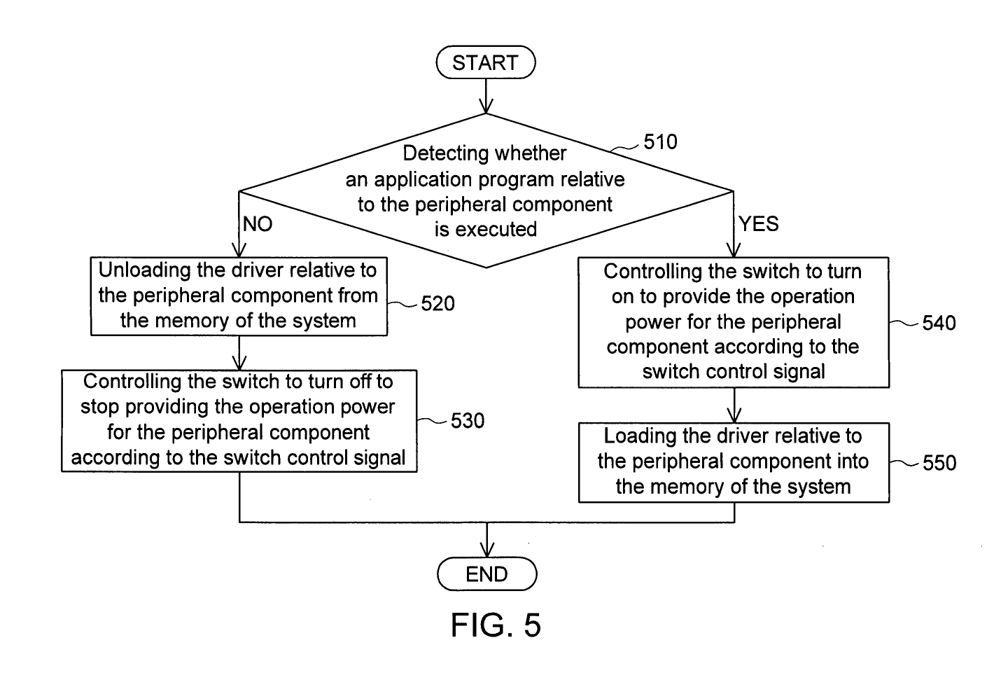

FIG. 5 is a flow chart showing a method for saving power in a computer system according to a preferred embodiment of the invention. As shown in FIG. 3 and FIG. 5, the method for saving power is applied to the computer system 30, and it includes the following steps. First, in the step 510, the CPU 362 executes the power halting driver 37 to detect whether the application program relative to the peripheral component 40 is executed and outputs the switch control signal S1.

When the application program relative to the peripheral component 40 is not executed, as shown in the step 520, the power halting driver 37 automatically unloads the driver of the peripheral component 40.

Next, in the step 530, when the peripheral component 40 loses its operation power Vcc, it enters a hot plug out state. The GPIO pin 3642 is programmed by the power halting driver 37 to output the switch control signal S1, and the switch control signal S1 controls the switch 32 to turn off. Then, the operation power Vcc is not provided for the peripheral component 40.

On the contrary, when the application program relative to the peripheral component 40 is executed, as shown in the step 540, the GPIO pin 3642 is programmed by the power halting driver 37 to output the switch control signal S1, and the switch control signal S1 controls the switch 32 to turn on. Then, the operation power Vcc is provided for the peripheral component 40.

As shown in the step 550, when the peripheral component 40 receives the operation power Vcc, the peripheral component 40 enters the hot plug in state. The computer system 30 re-loads the corresponding driver of the peripheral component 40 according to the device ID or the vendor ID of the peripheral component 40.

In the computer system and the method for dynamically saving power disclosed by the embodiments of the invention, whether to provide the operation power for the peripheral component is determined by detecting whether the application program relative to the peripheral component is executed, thereby saving the electricity of the battery of the computer system.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer system comprising:
a switch selectively and electrically connected to a peripheral component;
a system power supply unit electrically connected to the switch; and
an operation control unit electrically connected to the switch, wherein the operation control unit detects whether an application program relative to the peripheral component is executed and then outputs a switch control signal to the switch to determine whether the system power supply unit provides an operation power for the peripheral component.

2. The computer system according to claim 1, wherein the operation control unit comprises:
a central processing unit (CPU) for executing a power halting driver to detect whether an application program relative to the peripheral component is executed.

3. The computer system according to claim 2, wherein the power halting driver is between the hardware abstract layer (HAL) of an operating system and the driver of the peripheral component.

4. The computer system according to claim 2, wherein when the application program relative to the peripheral component is not executed, the power halting driver unloads the driver of the peripheral component.

5. The computer system according to claim 2, wherein when the application program relative to the peripheral component is executed, the power halting driver loads the driver of the peripheral component.

6. The computer system according to claim 1, wherein when the application program relative to the peripheral component is not executed, the switch control signal controls the switch to turn off to stop providing the operation power for the peripheral component.

7. The computer system according to claim 1, wherein when the application program relative to the peripheral component is executed, the switch control signal controls the switch to turn on to provide the operation power for the peripheral component.

8. The computer system according to claim 1, wherein the computer system further comprises:
a general purpose input output pin programmed to output the switch control signal to the switch according to whether the application program relative to the peripheral component is executed.

9. The computer system according to claim 1, wherein the operation control unit comprises:
a CPU for executing a power halting driver to detect whether an application program relative to the peripheral component is executed;
an embedded controller for outputting the switch control signal according to whether the application program relative to the peripheral component is executed; and
a chip set coupled between the CPU and the embedded controller.

10. The computer system according to claim 9, wherein the embedded controller further comprises:
a general purpose input output pin programmed to output the switch control signal to the switch according to whether the application program relative to the peripheral component is executed.

11. The computer system according to claim 2, wherein the power halting driver is a driver.

12. The computer system according to claim 1 further comprising:
a peripheral component controller for controlling the peripheral component.

13. The computer system according to claim 12, wherein the peripheral component and the peripheral component controller are a peripheral component supporting hot plug and play standard and a corresponding controller, respectively.

14. A method for dynamically saving power in a computer system comprising a switch and a system power supply unit, the method for dynamically saving power comprising the steps of:
(a) detecting whether an application program relative to a peripheral component is executed and then outputting a switch control signal; and
(b) controlling the switch according to the switch control signal to determine whether the system power supply unit provides an operation power for the peripheral component.

15. The method for dynamically saving power according to claim 14, wherein in the step (a), a power halting driver is executed to detect whether the application program relative to the peripheral component is executed.

16. The method for dynamically saving power according to claim 14, wherein in the step (b), when the application program relative to the peripheral component is not executed, the switch control signal controls the switch to turn off to stop providing the operation power for the peripheral component.

17. The method for dynamically saving power according to claim 14 further comprising the step of:
(c) unloading the driver of the peripheral component when the application program relative to the peripheral component is not executed.

18. The method for dynamically saving power according to claim 14, wherein in the step (b), when the application program relative to the peripheral component is executed, the switch control signal controls the switch to turn on to provide the operation power for the peripheral component.

19. The method for dynamically saving power according to claim 14, wherein the computer system further comprises a general purpose input output pin, and in the step (b), the general purpose input output pin is programmed to output the switch control signal to the switch according to whether the application program relative to the peripheral component is executed.

20. The method for dynamically saving power according to claim 19, wherein the computer system further comprises an embedded controller, and the general purpose input output pin is disposed at the embedded controller.
